(19) United States
(12) Patent Application Publication
(10) Pub. No.: US 2023/0308523 A1
(43) Pub. Date: Sep. 28, 2023

(54) METHOD AND APPARATUS FOR AUTO ARRAY DETECTION

(71) Applicant: Level 3 Communications, LLC, Broomfield, CO (US)

(72) Inventors: William C. CROWDER, Camarillo, CA (US); William POWER, Boulder, CO (US); Laurence LIPSTONE, Calabasas, CA (US)

(73) Assignee: Level 3 Communications, LLC, Broomfield, CO (US)

(21) Appl. No.: 18/182,935

(22) Filed: Mar. 13, 2023

Related U.S. Application Data
(60) Provisional application No. 63/362,018, filed on Mar. 28, 2022.

(51) Int. Cl. H04L 67/5682; H04L 67/306

(52) U.S. Cl. CPC H04L 67/5682; H04L 67/306

(57) ABSTRACT

External customer data (ECD) may be efficiently stored in a network. When ECD is received at an edge node, the node may determine if the ECD is subject to a compiling procedure. For example, if the ECD comprises a list of entries that all have the same data type, the ECD may be placed into an array, and the array may be sorted and stored. In other examples, if the ECD received at a node includes references to other ECD, the referenced ECD may be retrieved, and the received ECD and referenced ECD may be combined and stored. In other examples, the ECD received at the node may be script instructions that can then be compiled into, and stored as, a runtime version. Any compiled ECD stored at nodes may be subject to the same invalidation and expiration policies as the uncompiled ECD from which it was derived.

### CROSS-REFERENCE TO RELATED APPLICATIONS

This application claims the benefit of, and priority to, U.S. Provisional Application No. 63/362,018 filed Mar. 28, 2022, entitled “Method and Apparatus for Auto Array Detection,” which is incorporated herein by reference in its entirety.

### BACKGROUND

Providers of computer networks, such as local or wide area networks, public networks, content distribution networks (CDNs), and the like, may process and communicate large amounts of data on behalf of customers. In a CDN environment, for example, a client computing device may generate an electronic communication to a server in the CDN, where the electronic communication comprises a request for a transfer of data to the client. The CDN may need to perform certain customer-specific processing of such request.

It is with respect to this general computing environment that aspects of the present application are directed.

### SUMMARY

In examples, the present application discloses a method of managing external customer data (ECD) in a network. In some examples, the method comprises: receiving, at a node of the network, ECD comprising a plurality of list entries; determining whether all of the plurality of list entries comprise a same type of data; and in response to determining that all of the plurality of list entries comprise the same type of data, automatically: creating an array of the plurality of list entries; sorting the array of the plurality of list entries; and storing the sorted array.

In other examples, the present application discloses a method for managing external customer data (ECD) in a network, comprising: receiving ECD at a node of the network; determining, in response to receiving the ECD, whether the ECD is compilable; when the ECD is determined to be compilable, automatically compiling the ECD; and storing the compiled ECD.

In other examples, the present application discloses a system for managing external customer data (ECD) in a network, comprising at least one processor; and memory, operatively connected to the at least one processor and storing instructions that, when executed by the at least one processor, cause the system to perform a method. In examples, the method comprises receiving, at a node of the network, ECD comprising a plurality of list entries; determining whether all of the plurality of list entries comprise a same type of data; and in response to determining that all of the plurality of list entries comprise the same type of data, automatically: creating an array of the plurality of list entries; sorting the array of the plurality of list entries; and storing the sorted array.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE FIGURES

The present disclosure can be better understood with reference to the figures. In these figures, like reference numerals designate corresponding parts throughout the different figures and views.

FIG. 1 depicts an example system according to the present disclosure.

FIG. 2A depicts an example method for fulfilling a request for external customer data (ECD) according to the present disclosure.

FIG. 2B depicts an example method for processing and storing ECD according to the present disclosure.

FIG. 3 depicts an example method for compiling ECD according to the present disclosure.

FIG. 4 depicts another example method for compiling ECD according to the present disclosure.

FIG. 5 depicts another example method for compiling ECD according to the present disclosure.

FIG. 6 depicts an example computing environment with which one or more of the present systems and methods can be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the figures can comprise one or more machines or devices that are operatively connected to cooperate in order to provide the described system functionality. The following detailed description is therefore not to be taken in a limiting sense, and the scope of the present disclosure is defined by the appended claims and their equivalents.

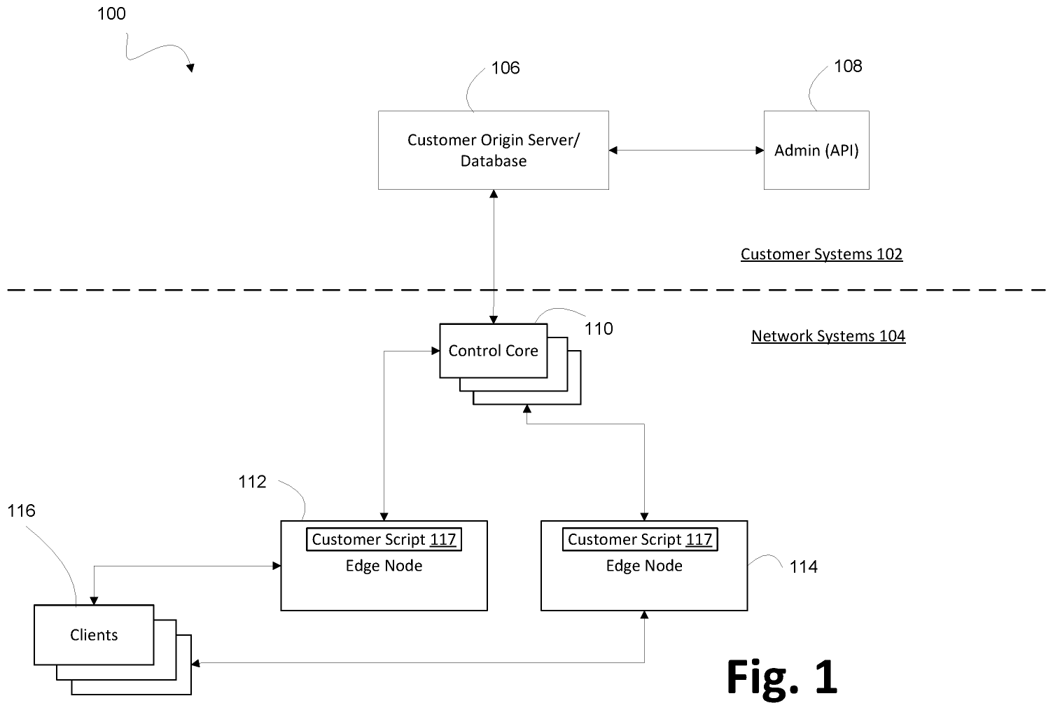

FIG. 1 illustrates a system 100 for ingesting, compiling, and delivering external customer data (ECD). In examples, components of system 100 may operate as a content delivery network (CDN), although the present application is not necessarily limited to any particular type of network. System 100 may comprise both customer systems 102 and network systems 104. For example, a customer of a network provider may maintain customer systems 102, which include a customer origin server/database 106 and an administrator system 108 to maintain/update the origin server/database 106 and cause updated customer configuration information to be replicated into network systems 104. Although only one customer origin server/database 106 and one administrator system 108 are depicted, multiple of each may be implemented. A network provider may, in turn, maintain network systems 104, which may comprise one or more control core 110, and edge nodes 112 and 114. In examples, network systems 104 are used to provide content and/or services to clients 116. In examples, clients 116 may comprise client devices that subscribe to services and/or access content provided by the customer using customer systems 102 and network systems 104.

In one nonexclusive example, a customer of the network provider provides content or services accessible by clients 116 on the network systems 104. Network systems 104 may comprise a CDN where content and/or computing services are delivered to clients via a logically closest edge node (e.g., edge node 112 or 116). Edge nodes 112 and 116 may also store and execute a customer script 117 that assists in the provisioning of the content or compute services to the clients 116.

Nonexclusive examples of CDNs that implement customer scripts are described in U.S. Patent Application Publication No. 2019/0327140, which is incorporated by reference herein. For example, as explained further in U.S. Patent Application Publication No. 2019/0327140, in examples, a content delivery network (CDN or CD network) distributes content (e.g., resources) efficiently to clients on behalf of one or more content providers (network customers). Customers of the CDN (e.g., content providers) provide their content (e.g., resources) via origin sources (origin servers or origins). A CDN can also provide an over-the-top transport mechanism for efficiently sending content in the reverse direction--from a client to an origin server. Both end-users (clients) and content providers benefit from using a CDN. Using a CDN, a content provider is able to take pressure off (and thereby reduce the load on) its own servers (e.g., its origin servers). Clients benefit by being able to obtain content with fewer delays.

Requests from clients 116 (e.g., for content) may be associated with edge nodes (such as edge nodes 112 and 114) by a rendezvous system comprising rendezvous mechanism(s). The rendezvous mechanism(s) may be implemented, at least in part, using or as part of a DNS system, and the association of a particular client request (e.g., for content) with one or more edge nodes may be done as part of DNS processing associated with that particular client request (e.g., of a domain name associated with the particular client request).

Typically, multiple edge nodes in the CDN can process or handle any particular client request for content (e.g., for one or more resources). Preferably the rendezvous system associates a particular client request with one or more “best” or “optimal” (or “least worst”) edge node to deal with that particular request. The “best” or “optimal” edge node (e.g., edge node 112 or 114) may be one that is close to the client 116 (by some measure of network cost) and that is not overloaded. Generally, the chosen edge node 112 or 114 (i.e., the edge node chosen by the rendezvous system for a client request) can deliver the requested content to the client 116 or can direct the client 116 to somewhere where the client 116 can try to obtain the requested content. A chosen edge node 112 or 114 need not have the requested content at the time the request is made, even if that chosen edge node 112 or 114 eventually serves the requested content to the requesting client.

In the CDN example, the control core 110 may include two components, namely a component dedicated to accepting and managing the configurations provided by CDN customers (also referred to as subscribers), and a component dedicated to controlling edge nodes (such as caching servers) based on established configurations. In other examples, a control core 110 may comprise any intermediate server between edge nodes 112, 114 and an origin server 106. The CDN may have or provide default policies and procedures for delivery and/or handling of subscriber content. These system defaults may be specified and/or contained in one or more system configuration files or objects. In addition, customers of the CDN (e.g., content providers) may customize aspects of delivery and/or handling of their content by the CDN. The customer customizations may be specified and/or contained in one or more customer configuration files or objects, such as scripts. The system default configuration may be augmented, supplemented, and/or replaced, at least in part, by customer configurations.

Configurations may be maintained, controlled, and administered, at least in part, by a configuration mechanism that may be accessed by CDN customers via an appropriate interface, such as a RESTful API, on administrator system 108. The configuration information may define, for a particular customer, for the customer's entire set of properties (e.g., pieces of content), and how the CDN should handle those properties (e.g., how the CDN should service requests for that customer's properties). This may include, alias hostnames, origin servers from which to fill, and all policies associated with content associated with that customer.

In examples, network systems 104 may comprise a request/response mechanism may allow customer-specific handlers, or sequences, to be included at various locations during request/response processing for that customer's content. The customer-specific scripts that are used to process a customer's requests may be referred to as Customer Configuration Scripts (CCSs). In examples, a customer configuration may include one or more customer script 117 that is executed at edge nodes 112 and 114 to control aspects of responding to requests from clients 116. For example, customer script 117 may comprise an access control script that determines whether a particular client 116 should be given access to the content or resources requested by the client 116. Edge nodes 112 and 116 may execute multiple customer scripts 117 that are specific to properties of different customers.

As used herein, the terms “resource” and “content” refer to, without limitation, any and all kinds of resources and/or content that may be provided to a computing device by another computing device, such as to users' computers via CDNs. Resources and/or content may be any static or dynamic data item comprising an arbitrary sequence of bits, regardless of how those bits are stored or transmitted, and regardless of what those bits represent. A resource provided by a CDN, for example, may comprise data representing some or all of another resource, including a file, a portion of a file, a digital message, a portion of a digital message, a digital image, a portion of a digital image, a video signal, a portion of a video signal, an audio signal, a portion of an audio signal, a software product, a portion of a software product, a page in memory, a web page, a movie, a portion of a movie, and the like. This list is provided only as an example, it is not intended to be limiting in any way.

In examples, customer script 117 may require ECD provided and/or maintained by the customer in order to operate. In examples, customer script 117 may implement the business logic that is specific to the customer for handling requests received by the CDN for that customer's properties. The ECD, by contrast, is data that is also specific to the customer, but it is data that the customer script 117 requires in order to implement the business logic for that customer. Administrator system 108 may be provided with an interface for an administrator of customer systems 102 to upload, modify, and/or delete ECD on which customer script 117 operates. For example, if customer script 117 is an access control script, it may require ECD in the form of a list of device identifiers that identify one or more clients 116 that are permitted to access, or are prohibited from accessing, particular content or compute services of the customer. For example, the ECD may comprise an exclusion list of device identifiers that are prohibited from accessing particular content or services stored on, or provided by network systems 104, on behalf of the network customer. When a request is received at edge node 112 or 114 for access to particular content or services, the request may include a uniform resource locator (URL) associated with the requested content or services. The customer script 117 may then be configured to obtain or query a current list of device identifiers that are prohibited from accessing that URL to determine whether to grant access.

Scripts may be cached objects, similar to other objects stored in network systems 104. Scripts may be compiled into byte code and executed in a sandbox by a virtual machine. In one example, scripts are implemented using the Lua scripting language. Those skilled in the art will realize that a scripting language other than Lua could be used to implement the teachings of the present disclosure. However, the scripting language that is used should, in examples, run, or be interpreted, quickly with a small interpreter, have a relatively small implementation, be lightweight, i.e. have a small memory footprint and be easily sandboxed for secure execution, and provide sufficient control to allow customer-derived scripts to be used. In each embodiment, however, “script” does not necessarily imply something interpreted at run time, but rather it is used in a broader sense to mean loadable code.

In examples described below, the ECD associated with the customer script 117 may be generated/stored in a first format at customer origin server/database 106 and control core 110, but compiled into a second format to make it more useful for the customer script 117 and stored at edge nodes 112 and 116. Among other things, this allows an administrator using administrator system 108 to update ECD used to control access to the content/services provided by the customer to clients 116 without requiring knowledge of, or access to, the code of customer script 117. For example, an exclusion list of device identifiers may be uploaded, edited, and/or deleted via administrator system 108, via an application programming interface (API), to customer origin server/database 106. In examples, the list is input in a first format, such as JavaScript object notation (JSON), though the present application is not necessarily limited to a particular input format. In examples, the exclusion list of device identifiers is stored at customer origin server/database 106 in JSON and periodically replicated to control core 110 within network systems 104 (and eventually to edge nodes 112/114). In examples, the ECD (in this case, the exclusion list of device identifiers) is stored at control core 110 in the same format as in customer origin server/database (in this example, in JSON format).

The copy of the ECD stored at control core 110 may be subject to invalidation policies. In examples, the invalidation policies for ECD may be independent from any invalidation policies for customer script(s) 117 that use the ECD. For example, when a copy of the ECD is stored at control core 110, it may be associated with a time to live (TTL) value, after which the copy of the ECD is considered stale or invalid. In examples, the TTL value may be communicated to the control core 110 in a hypertext transfer protocol (HTTP) Cache-Control header when the ECD is transmitted to the control core 110. In examples, the TTL of the copy of the ECD stored at the control core 110 is the same as the TTL value (if any) associated with the ECD stored at the customer origin server/database 106. In other examples, the TTL of the copy of the ECD stored at the control core 110 is independent of any TTL associated with the ECD stored at the customer origin server/database 106. In examples, control core 110 may request a new version of the ECD before a TTL expires, or control core 110 may request a new version of the ECD only when the control core receives a request for the ECD from an edge node 112 or 114 and determines that it currently is not currently storing an unexpired version of such ECD. In examples, the copy of the ECD stored at control core 110 is also subject to direct invalidation. For example, if changes are made to ECD stored at customer origin server/database 106, those changes may automatically be propagated to control core 110 with a corresponding new associated TTL for such ECD, and any previous version(s) of the ECD stored at control core 110 may be automatically invalidated.

The ECD stored at control core 110 may be distributed to edge nodes 112 and 114. For example, ECD may be distributed from control core 110 to edge nodes 112 and 114 each time an update to the ECD stored at control core 110 is received at control core 110. In other examples, the ECD is distributed from control core 110 to an edge node, such as edge node 112 or 114, when the edge node (e.g., 112 or 114) requests it. For example, a cache or other component at the edge node may receive a request from customer script 117 for the ECD, determine that the ECD is not stored at the edge node, and request the ECD from the control core 110. The ECD may then be stored (in compiled and/or uncompiled form, as discussed further below) in a cache associated with the edge node. For example, edge nodes 112 and 114 may each comprise one or more computing devices, memory, and associated cache storage to store recently requested ECD and/or popular content at edge nodes 112 and 114 for quicker delivery to clients 116 or use by customer script 117.

In examples, when ECD is received at an edge node, such as edge node 112 or 114, the edge node may determine if the ECD is subject to a compiling procedure. Several examples of ECD that is subject to compiling are discussed below. For example, the ECD may comprise a list of entries that all have the same data type. In examples, the contents of the ECD list are provided in JSON format. For example, the ECD may comprise a JSON list of device identifiers all of the same data type. The JSON format may comprise specific data types, comprising strings of characters, numbers, arrays, Boolean values, and the like.

In examples, if the ECD is detected by an edge node 112 or 114 to be a list of all the same data type, the ECD may be placed into an array, and the array may be sorted. The sorted array may be considered “compiled” ECD, and the compiled ECD may be stored at the edge node. In some examples, the sorted array may be created and stored automatically by the edge node upon receipt of the ECD that is determined to be all of the same data type, even before any customer script 117 requests such ECD.

In examples, the original ECD is transformed into a form that is easier for the customer script 117 to consume. For example, if the original ECD is JSON list and the customer script 117 is a Lua script, the original ECD may be compiled into compiled ECD (e.g., a sorted array) that appears to the customer script 117 as a Lua table. The compiled ECD may be provided to (e.g., exposed to functions of) the Lua script. In the example where the ECD comprises a device identifier list used by a customer script 117 that performs access control for customer-provided resources, the Lua script (e.g., customer script 117) may query the compiled ECD, e.g., by making a defined Lua function call, to determine whether a device identifier for a requesting client 116 is contained in the sorted ECD list. Based on whether the device identifier for the requesting client 116 is found, the customer script 117 may permit or deny access to the requested resource by client 116.

Further, in other examples, the ECD that is received at an edge node may be subject to different types of “compiling.” For example, if the ECD received at an edge node includes references to other ECD, the referenced ECD may be retrieved, and the received ECD and referenced ECD may be combined and stored at the edge node in a compiled form. In other examples, the ECD received at the edge node may be script instructions. In examples, the ECD can then be compiled into a runtime version of the scripting language employed by the customer script 117. For example, the ECD may comprise character strings that are portions of a script that are provided in JSON format, and customer script 117 may comprise a Lua script. The instructions received in JSON format may be compiled into runtime Lua instructions and stored in compiled form at edge nodes 112 and 114 for use by customer script 117. Other types of ECD may also be automatically compiled into a form to be more easily consumed by customer scripts at the edge nodes.

In examples, edge node 112/114 maintains a reference to the compiled form of the ECD. For example, a customer script 117 may query for the ECD, and if the reference to the compiled ECD already exists, the compiled ECD is provided (and the compilation procedure need not be repeated). The compiled ECD is available at the edge node 112/114 until it expires or is invalidated.

In examples, any compiled ECD stored at edge nodes 112 and 114 may be subject to the same invalidation and expiration policies as the uncompiled ECD from which it was derived. For example, if uncompiled ECD is received at control core 110 and pushed to (or pulled by) edge nodes 112 and 114, the control core 110 may communicate the expiration policy for that ECD to the edge nodes 112 and 114. In examples, as discussed, the control core 110 may store a TTL of the ECD with the uncompiled version of the ECD stored at the control core 110. The TTL may also be communicated with the uncompiled ECD to the edge nodes 112 and 114, e.g., in a hypertext transfer protocol (HTTP) Cache-Control header when the ECD is transmitted to the edge nodes 112 and 114. Edge nodes 112 and 114 may then compile the ECD and store the compiled ECD with a TTL or other invalidation/expiration policy that is the same as for the underlying uncompiled ECD. Further, if the control core 110 receives a direct invalidation of the underlying ECD (e.g., from the customer origin server/database 106), then it may communicate a direct invalidation of the underlying ECD to the edge nodes 112 and 114, which will, in turn, also mark as invalid any corresponding compiled ECD. In some examples where the invalidation is due to ECD being updated, the ECD may not be marked as invalid until the updated ECD has been retrieved and processed by the edge nodes 112 and/or 114. In such examples, the customer script 117 may continue to use the previously compiled ECD until the new ECD is received and ready to use at edge nodes 112 and/or 114, respectively. In other examples, the edge nodes 112 and 114 may mark ECD that is being updated as immediately invalid, and the script 117 must wait until the ECD has been received and is ready to use at edge nodes 112 and/or 114. As used herein, marking the compiled ECD as invalid may include or comprise deleting the compiled ECD. In this manner, the compiled ECD may be made subject to the same invalidation/expiration policies as any uncompiled ECD at the control core 110 (or customer origin server/database 106).

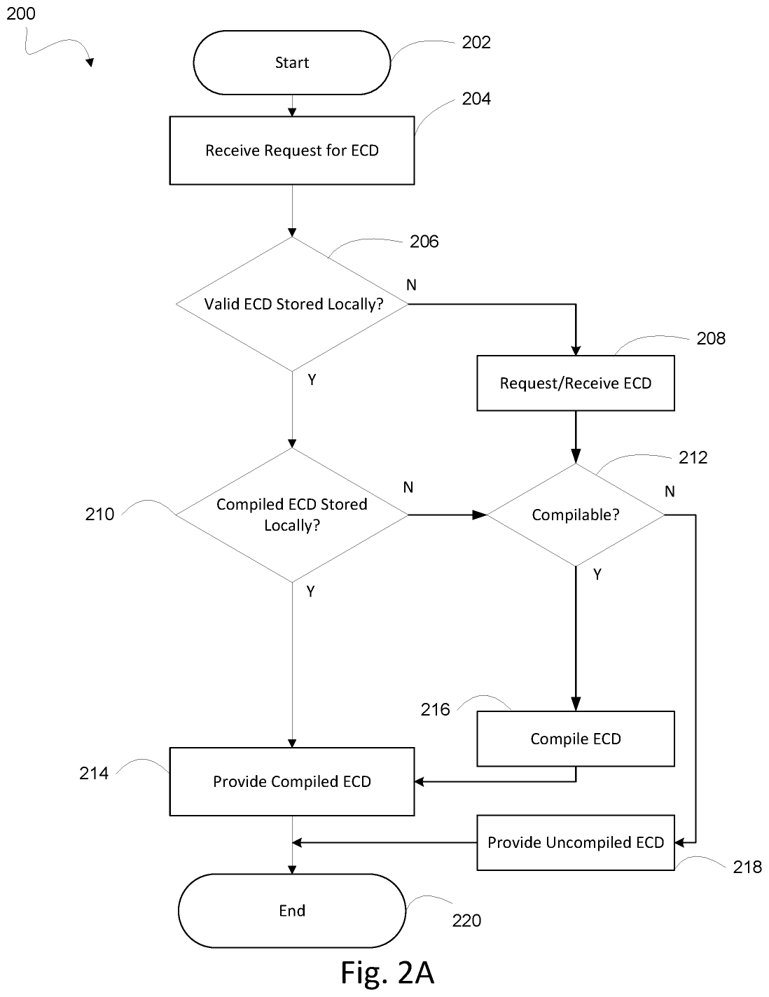

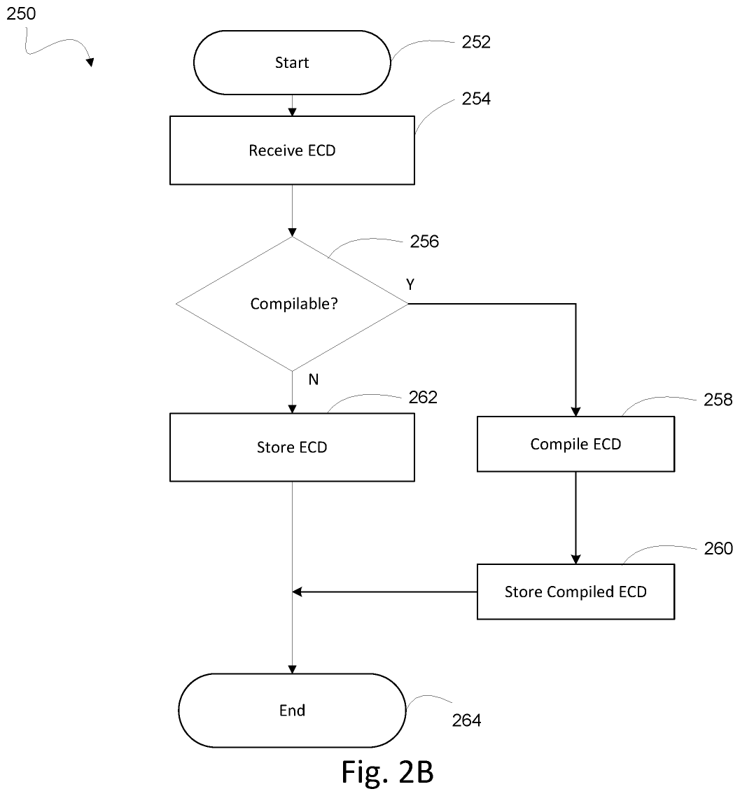

FIG. 2A is an example method 200 for responding to a request for ECD. In examples, method 200 may be performed by an edge node, such as edge node 112 or 114. The method 200 starts 202 and proceeds to operation 204, where a request for ECD is received. In examples, a component of an edge node, such as edge node 112 or 114, may receive a request from a customer script, such as customer script 117, for ECD needed by the customer script. In the example where the customer script 117 is an access control script, the ECD may comprise an access control list (either an exclusion list or an allow list) that informs the decision of the customer script 117 whether to allow access by a client 116 to content stored in network systems 104. As used herein, the request for the ECD at operation 204 may be comprise a request for the ECD to be returned, a request to query the ECD, a binding call, or another indication that the customer script 117 needs the ECD or to use the ECD. In examples, the request may include a uniform resource locator (URL) for the location of the ECD in its uncompiled form. For example, where the ECD comprises an access control list, a customer script 117 may need to query whether a particular device identifier appears on the access control list and provide a URL for the uncompiled form of the URL.

Flow proceeds to operation 206, where a decision is made whether valid ECD is stored locally. For example, the edge node 112 or 114 may determine whether a version of the ECD requested by control script 117 is stored within a cache or other storage associated with the edge node. In examples, a determination is made whether the requested ECD is stored locally and whether the locally stored version is still valid (e.g., the TTL has not expired). In examples, the determination at operation 206 may occur in response to the request for the ECD at operation 204 or at another time (e.g., periodically).

If a valid version of the requested ECD is not stored locally, flow proceeds to operation 208, where the ECD is requested and received. For example, an edge node 112/114 may request and receive the ECD from control core 110, as described above. Flow then proceeds to operation 212, where it is determined whether the received ECD is compilable, which is described in greater detail below.

If a valid version of the requested ECD is determined at operation 206 to be stored locally, in examples, flow proceeds to operation 210, where it is determined whether the ECD stored locally is compiled ECD. For example, the edge node 112 or 114 may have received the ECD (such as an access control list) from the control core 110 but not yet compiled it. In examples, the ECD may be pushed regularly by control core 110 to edge nodes 112 and 114, but compiled at the edge nodes 112 and 114 only when it is requested, e.g., by a customer script 117. In other examples, the edge nodes 112 and 114 automatically compile the ECD upon receipt from the control core 110, regardless of any request from a customer script 117. In other examples, the ECD may be received at the edge nodes 112 and 114 only in response to a request for the ECD from a customer script 117 (and corresponding request from an edge node 112 or 114 to control core 110), so it is automatically compiled by the edge node 112/114 when received. Further, operation 210 may, in examples, be combined with operation 206.

If, at operation 210, it is determined that the ECD stored locally has already been compiled, the compiled ECD is provided at operation 214. For example, a cached version of the compiled ECD at edge node 112/114 is provided to customer script 117, which may use it to perform customer-specific processing of a request (such as a request from client 116 to access content on network systems 104). In examples, providing the compiled ECD to the customer script 117 may comprise exposing the compiled ECD to one or more functions or methods of the customer script 117. For example, the customer script 117 may include a function that queries the compiled ECD to determine whether the compiled ECD comprises a particular value. In the example where the ECD comprises an access control list, providing the ECD to the customer script 117 may comprise exposing the compiled ECD to the customer script 117 to allow the customer script 117 to efficiently determine whether a particular client device identifier appears on the access control list, as described further herein.

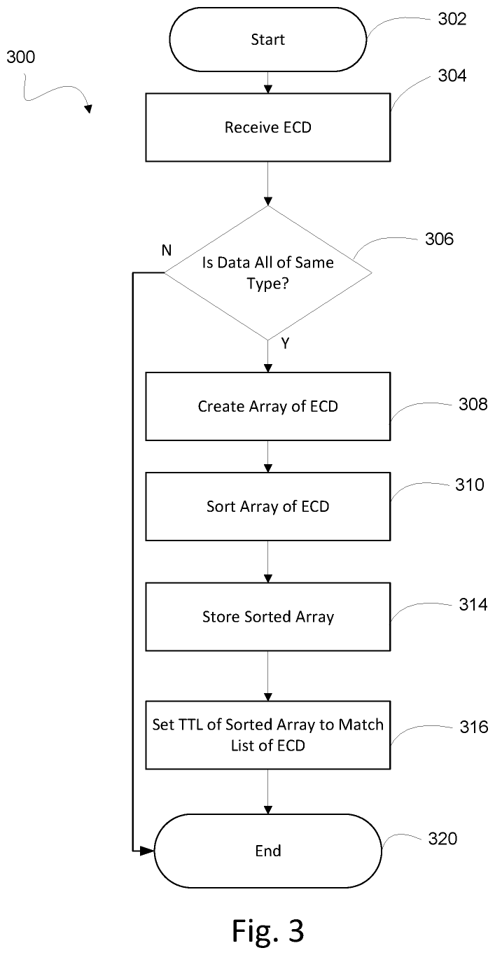

If, at operation 210, it is determined that the ECD stored locally has not already been compiled, or if flow is proceeding from operation 208, a determination is made at operation 212 whether the ECD is compilable. For example, a determination is made whether the ECD (previously stored at edge node 112/114 or received at operation 208) is subject to one or more compiling procedures. As discussed, in examples, operation 212 may comprise determining whether the ECD is all of the same data type. In other examples, the operation 212 may comprise determining whether the ECD includes references to other ECD. In other examples, operation 212 may comprise determining whether the ECD comprises script instructions. If the ECD is determined to be compilable, flow proceeds to operation 216, where the ECD is compiled, and the compiled ECD is provided (e.g., to the requesting customer script 117) at operation 214. Examples of operations 212 and 216 are discussed, e.g., in relation to FIGS. 3, 4, and 5 below. Providing the compiled ECD at operation 214 may comprise permitting a requesting process (such as customer script 117) to consume the ECD, e.g., by exposing the compiled ECD to one or more functions or methods of the customer script 117. For example, the customer script 117 may include a function that queries the compiled ECD to determine whether the compiled ECD comprises a particular value. In one example, a customer script 117 that is performing an access control function may efficiently query compiled ECD to determine whether a particular client 116 should be permitted access to content stored by network systems 104 on behalf of the customer. Other examples of consuming or using the compiled ECD that is provided at operation 214 are contemplated.

If the ECD is determined at operation 212 to not be subject to compiling, then the uncompiled ECD is provided at operation 218 (e.g., to the requesting customer script 117). For example, another process or system at edge node 112/114 may consume the ECD in uncompiled form and/or compile the uncompiled ECD for a different purpose or using a different process. Method 200 ends at operation 220.

FIG. 2B depicts a method 250 for receiving and storing ECD. In examples, the method 200 may be performed by one or more of edge nodes 112 and 114. Method 250 starts at operation 252 and flow proceeds to operation 254, where ECD is received. In examples, an edge node 112/114 may receive the ECD from control core 110. As discussed, ECD may be received at an edge node 112/114 in response to a request from the edge node 112/114. The request from the edge node 112/114 may be prompted by a request from a customer script 117 for the ECD. In other examples, however, the edge node 112/114 may request ECD from control core 110 periodically, in response to a TTL for the ECD expiring (or nearing expiration), or otherwise. In other examples, the ECD may be received at operation 254 because it is pushed automatically by the control core to the edge node(s) 112/114 without a request from the edge node(s) 112/114. For example, the control core 110 may push the ECD to the edge node(s) 112/114 periodically and/or every time the control core 110 receives new ECD or updated ECD (e.g., from customer origin server/database 106). In other words, receiving ECD at operation 254 may be in response to a request (e.g., a request from customer script 117 or edge node 112/114) or may not be associated with a particular request for the ECD.

At operation 256, it is determined whether the ECD is compilable. As discussed, in examples, operation 256 may comprise determining whether the ECD is all of the same data type. In other examples, the operation 256 may comprise determining whether the ECD includes references to other ECD. In other examples, operation 256 may comprise determining whether the ECD comprises script instructions. If the ECD is determined to be compilable, flow proceeds to operation 258, where the ECD is compiled. The compiled ECD is stored at operation 260, such as in a cache associated with an edge node 112/114. Examples of operations 256, 258, and 260 are discussed in relation to FIGS. 3, 4, and 5 below. If it is determined that the ECD is not subject to compilation at operation 256, then the uncompiled ECD is stored at operation 262, such as in a cache associated with an edge node 112/114. Method 250 ends at operation 264.

FIG. 3 is an example method 300 for determining whether ECD is compilable and storing the ECD. In examples, method 300 may be performed by one or more of the edge nodes 112 and 114. Further, in examples, method 300 may comprise one or more of the operations 208, 212, and 216 of FIG. 2A or operations 254, 256, 258, 260, and 262 of FIG. 2B. Method 300 starts at operation 302 and flow proceeds to operation 304, where ECD is received. As discussed, in examples, the ECD is received by an edge node 112/114 from a control core 110 either in response to a request for the ECD or otherwise.

Flow proceeds to operation 306, where it is determined whether all of the ECD is of the same type. In examples, operation 306 may be an example of operation 212 in FIG. 2A or operation 256 in FIG. 2B. In examples, the ECD may comprise a list. For example, at operation 306, the edge node 112/114 may determine whether the list that is received, e.g., from the control core 110 contains only values of the same type. For example, where the ECD is an access control list, the ECD may comprise a JSON list of device identifiers all of the string type or number type. In examples, if the ECD is not of all the same type, then flow branches to operation 320, where the method 300 ends.

If the ECD is all of the same type, flow branches to operation 308, where an array of ECD is created. In examples, a received list of ECD may be all of the same type; however, the list may be unsorted, which makes it more difficult for a customer script, such as customer script 117, to consume. For example, a customer system 102 may periodically update or change a version of the ECD that is stored at customer origin server/database 106. The ECD need not be maintained in any particular format at server/database 106, as the administrator of customer system 102 may not be familiar with particular requirements of the customer script 117 maintained at edge nodes 112/114. Thus, the updated ECD (e.g., an unsorted list) may be replicated to control core 110 and eventually pushed to (or pulled by) edge nodes 112/114.

As mentioned, after the ECD is received and determined to be all of the same data type, flow proceeds to operation 308, where an array is created from the ECD. In examples, operation 308 may be performed in response to the determination that all of the ECD is of the same type and before receiving a particular request for the ECD. In other words, operation 308 may be performed as a recognition that a list of data all having the same type is likely to be a list that one or more scripts or other processes are likely to want to search. In examples where the ECD is a JSON list, an edge node 112/114 may extract the ECD entries (e.g., device identifiers) from a JSON list and place them into an array. Flow proceeds to operation 310, where the array is sorted. For example, the device identifiers may be sorted into a particular order (e.g., alphabetical, numerical, etc.).

In examples, the sorted array may be considered “compiled” ECD. In some examples, the sorted array may be created and stored automatically by the edge node upon receipt of the ECD that is determined to all of the same data type, even before any customer script 117 requests such ECD. In examples, the original ECD is thus transformed into a form that is easier for the customer script 117 to consume. For example, if the original ECD is a JSON list and the customer script 117 is a Lua script, the original ECD may be compiled into compiled ECD (e.g., a sorted array) that appears to the customer script 117 as a Lua table. The compiled ECD is more efficiently queried by the Lua script. In the example where the ECD comprises a device identifier list used by a customer script 117 that performs access control for customer-provided resources, the Lua script (e.g., customer script 117) may then query the compiled ECD, e.g., by making a defined Lua function call, to determine whether a device identifier for a requesting client 116 is contained in the sorted ECD list.

Flow proceeds to operation 314, where the sorted array is stored. For example, the edge node 112/114 may store the sorted array in a cache associated with the edge node 112/114. Flow then proceeds to operation 316, where an expiration policy for the compiled ECD is set. For example, a TTL for the sorted array may be set to be the same as any TTL for the ECD that was received at operation 304. As discussed, any compiled ECD stored at edge nodes 112 and 114 may be subject to the same invalidation and expiration policies as the uncompiled ECD from which it was derived. For example, if uncompiled ECD is received at control core 110 and pushed to (or pulled by) edge nodes 112 and 114, the control core 110 may communicate the expiration policy for that ECD to the edge nodes 112 and 114. In examples, the TTL may be communicated by control core 110 with the uncompiled ECD to the edge nodes 112 and 114, e.g., in a hypertext transfer protocol (HTTP) Cache-Control header when the ECD is transmitted to the edge nodes 112 and 114. Further, if the control core 110 receives a direct invalidation of the uncompiled ECD (in this instance, the unsorted list), then it may communicate a direct invalidation of the underlying ECD to the edge nodes 112 and 114, which will, in turn, also mark as invalid the corresponding compiled ECD (the sorted array). In examples, operations 314 and 316 may be combined.

Flow proceeds to operation 320, where method 300 ends.

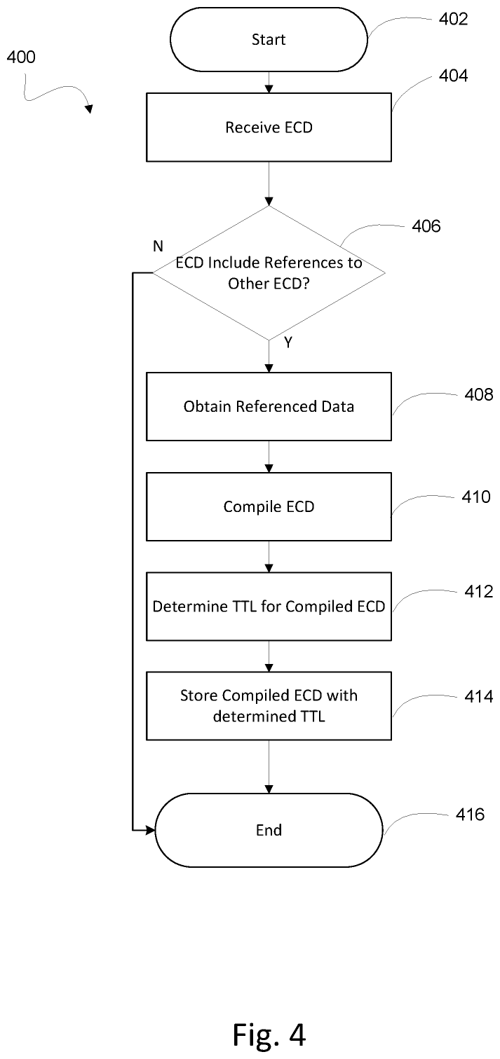

FIG. 4 is an example method 400 for determining whether ECD is compilable and storing the ECD. In examples, method 400 may be performed by one or more of the edge nodes 112 and 114. Further, in examples, method 400 may comprise one or more of the operations 208, 212, and 216 of FIG. 2A or operations 254, 256, 258, 260, and 262 of FIG. 2B. Method 400 starts at operation 402 and flow proceeds to operation 404, where ECD is received. As discussed, in examples, the ECD is received by an edge node 112/114 from a control core 110 either in response to a request for the ECD or otherwise.

Flow proceeds to operation 406, where it is determined whether the ECD includes references to other ECD. In examples, operation 406 may be an example of operation 212 in FIG. 2A or operation 256 in FIG. 2B. For example, the ECD may contain internal references (such as links) to other ECD stored in network systems 104 or otherwise. If it is determined at operation 406 that the ECD does not include references to other ECD, then flow branches to operation 416, and the method 400 ends.

If it is determined at operation 406 that the received ECD does include references to other ECD, then the referenced ECD is obtained at operation 408. In examples, this may include requesting and receiving the referenced ECD from one or more storage locations within network systems 104 or otherwise. In examples, operation 408 may be performed automatically in response to the determination that the received ECD contains references to other ECD and before receiving a particular request for the ECD. In other words, operation 408 may be performed as a recognition that the referenced ECD is likely to be requested and that it should be pre-fetched.

Flow proceeds to operation 410, where the ECD is compiled. For example, this operation may include combining the ECD received at operation 404 with referenced ECD obtained at operation 408. Flow proceeds to operation 412, where an expiration or invalidation policy for the compiled ECD is determined. For example, a TTL for the compiled ECD may be determined based on corresponding TTLs for the ECD received at operation 404 with referenced ECD obtained at operation 408. In examples, the ECD received at operation 404 may have a first TTL that is communicated by the control core 110 when the ECD is sent to the edge node 112/114, while the referenced ECD obtained at operation 408 may have a second TTL that is different from the first TTL and is communicated by the storage location from which the referenced ECD is obtained. In examples, the compiled ECD may thus have more than one TTL for different portions of the compiled ECD. In other examples, the TTL of the compiled ECD may be the shortest TTL that is applicable to any portion of the compiled TTL. Flow then proceeds to operation 414, where the compiled ECD is stored along with whatever determined TTL or other expiration/invalidation policy is applicable. For example, the edge node 112/114 may store the compiled ECD in a cache associated with the edge node 112/114. Further, if the control core 110 (or a storage location from which referenced ECD is retrieved) receives a direct invalidation of the uncompiled ECD, then it may communicate a direct invalidation of the underlying ECD to the edge nodes 112 and 114, which will, in turn, also mark as invalid the corresponding compiled ECD. In examples, operations 412 and 414 may be combined.

Flow proceeds to operation 416, where method 400 ends.

Further, examples, the operations of FIGS. 3 and 4 could be combined. For example, the ECD may comprise a list of items all of the same data type and also include a reference to another list of items of the same data type. In examples, compiling of that ECD may include obtaining the referenced additional list of items, combining the two lists, and then creating a sorted array for the combined list. Other combinations of methods and systems described herein are also possible.

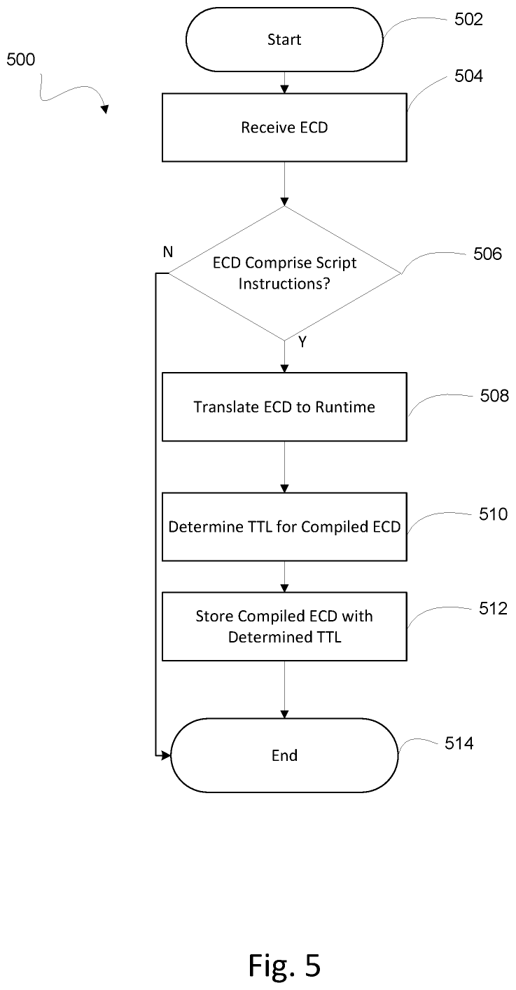

FIG. 5 illustrates another example method 500 for determining whether ECD is compilable and storing the ECD. In examples, method 500 may be performed by one or more of the edge nodes 112 and 114. Further, in examples, method 500 may comprise one or more of the operations 208, 212, and 216 of FIG. 2A or operations 254, 256, 258, 260, and 262 of FIG. 2B. Method 500 starts at operation 502 and flow proceeds to operation 504, where ECD is received. As discussed, in examples, the ECD is received by an edge node 112/114 from a control core 110 either in response to a request for the ECD or otherwise.

Flow proceeds to operation 506, where it is determined whether the ECD comprises script instructions. In examples, operation 506 may be an example of operation 212 in FIG. 2A or operation 256 in FIG. 2B. For example, the ECD may comprise script instructions that are intended to modify customer script 117. For example, the ECD may comprise character strings that are portions of a script that are provided in JSON format. This may be useful because the customer script 117 may be in a form that is unfamiliar, or unavailable, to an administrator of customer systems 102. For example, the customer script comprises a Lua script that is not visible or directly editable by the customer systems 102. However, the administrator of the customer systems 102 may be provided the ability to provide certain instructions in character strings in JSON format. The determination of whether the received ECD comprises script instructions may be done in a variety of ways. For example, pattern recognition may recognize the ECD as comprising script instructions. Or the ECD may include a header that is recognized by the receiving component (e.g., control core 110 or edge node 112/114) as indicating that the ECD comprises script instructions. Other methods of identifying or determining that the ECD comprises script instructions are possible and anticipated. Also, as used herein, “script” is not limited to a traditional “scripting” language and may encompass any computing language. If it is determined at operation 506 that the ECD does not comprise script instructions, then flow branches to operation 514, and the method 500 ends.

If it is determined at operation 506 that the received ECD does comprise script instructions, then the script instructions are translated into a runtime version at operation 508. In examples, this may include translating the ECD into a runtime version of the language used by customer script 117. For example, if the script instructions are received as ECD in character strings of a JSON file, and the customer script 117 is a Lua script, then the ECD may be translated into a runtime Lua script. In examples, operation 508 may comprise replacing, modifying portions of, or otherwise altering the operation of customer script 117. In examples, operation 508 may be performed automatically in response to the determination that the received ECD contains script instructions.

Flow proceeds to operation 510, where an expiration or invalidation policy for the compiled ECD is determined. For example, a TTL for the compiled ECD (in this case, the translated runtime script) may be determined based on a corresponding TTL for the ECD received at operation 504. In examples, the ECD received at operation 504 may have a TTL that is communicated by the control core 110 when the ECD is sent to the edge node 112/114.

Flow then proceeds to operation 512, where the compiled ECD is stored along with whatever determined TTL or other expiration/invalidation policy is applicable. For example, the edge node 112/114 may store the compiled ECD in a cache associated with the edge node 112/114. Further, if the control core 110 receives a direct invalidation of the uncompiled ECD, then it may communicate a direct invalidation of the underlying ECD to the edge nodes 112 and 114, which will, in turn, also mark as invalid the corresponding compiled ECD. In examples, operations 510 and 512 may be combined.

Flow proceeds to operation 514, where method 500 ends.

Among other technical effects, the systems and methods of the present application improve computing efficiency and user efficiency. For example, in some examples, the expiration and invalidation policies applicable to underlying ECD may be automatically applied to compiled ECD. In addition, disparate ECD from multiple customers in multiple formats may be deployed, managed, and compiled for use in network systems 104. In examples, this permits customers to manage their ECD that is deployed and compiled within network systems 104 from their own customer systems 102 and without requiring all customers to comply with a common data structure necessitated by network systems 104.

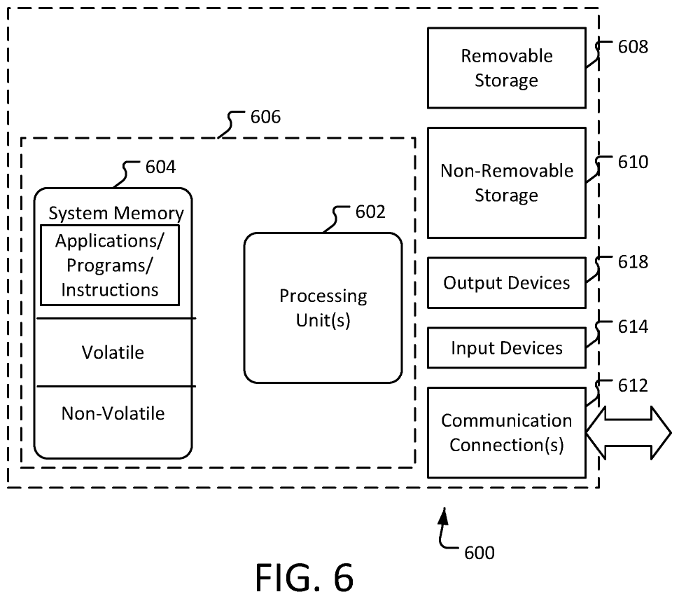

FIG. 6 is a block diagram illustrating physical components (i.e., hardware) of a computing device 600 with which examples of the present disclosure may be practiced. The computing device components described below may be suitable for a computing device(s) implementing one or more of the edge nodes 112/114, control core 110, clients 116, and other components of system 100. In a basic configuration, the computing device 600 may include at least one processing unit 602 and a system memory 604. The processing unit(s) (e.g., processors) may be referred to as a processing system. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software applications 650 to implement one or more of the systems described above with respect to FIG. 1.

The operating system 605, for example, may be suitable for controlling the operation of the computing device 600. Furthermore, aspects of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including, but not limited to, one or more of the operations of the methods illustrated in FIGS. 2-5. Other program modules that may be used in accordance with examples of the present invention and may include applications 650 such as web browser 621, electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 600 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 600 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports. In examples, communications connections 616 may also include any necessary electrical networks between and among components of the presently described systems.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. Systems depicted as blocks may be communicatively connected to one or more other systems described, whether or not such connection(s) is/are drawn as such. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

We claim:

1. A method of managing external customer data (ECD) in a network, comprising:
receiving, at a node of the network, ECD comprising a plurality of list entries;
determining whether all of the plurality of list entries comprise a same type of data; and
in response to determining that all of the plurality of list entries comprise the same type of data, automatically:
creating an array of the plurality of list entries;
sorting the array of the plurality of list entries; and
storing the sorted array.

2. The method of claim 1, further comprising:
receiving a request for the ECD from a script operating on the node; and
providing the sorted array to the script in response to the request.

3. The method of claim 1, wherein providing the sorted array comprises exposing the sorted array to the script.

4. The method of claim 1, further comprising:
receiving a query from a script operating on the node whether the list entries comprise at least a particular entry;
searching the plurality of list entries using the sorted array; and
providing a response based on whether the particular entry matches one of the list entries.

5. The method of claim 1, wherein the node comprises an edge node of a content distribution network, and wherein receiving the metadata comprises receiving the metadata at the edge node from a control core of the content distribution network, the method further comprising:
receiving the ECD at the control core from a customer server; and
automatically propagating the ECD to the edge node.

6. The method of claim 1, further comprising:
determining an expiration policy for the ECD; and
automatically applying the expiration policy for the ECD to the sorted array stored at the node.

7. The method of claim 1, further comprising:
receiving an indication at the node that the ECD has been invalidated; and
automatically marking the sorted array stored at the node as invalid.

8. A method for managing external customer data (ECD) in a network, comprising:
receiving ECD at a node of the network;
determining, in response to receiving the ECD, whether the ECD is compilable;
when the ECD is determined to be compilable, automatically compiling the ECD; and
storing the compiled ECD.

9. The method of claim 8, wherein the ECD comprises a plurality of list items, and determining whether the ECD is compilable comprises determining whether all of the list items of a same data type.

10. The method of claim 8, wherein:
determining whether the ECD is compilable comprises determining whether the ECD includes references to separately stored ECD; and
compiling the ECD comprises obtaining the separately stored ECD.

11. The method of claim 8, wherein:
determining whether the ECD is compilable comprises determining whether the ECD comprises script instructions; and
compiling the ECD comprises compiling the script instructions into a runtime script.

12. The method of claim 8, wherein the network comprises a content delivery network, the method further comprising:
providing an interface for a customer of the network to upload the ECD;
receiving the ECD at a control core of the content delivery network; and
propagating the ECD to the node from the control core.

13. The method of claim 12, further comprising:
receiving, at the node, a request for content from a client; and
processing the request at the node based on the compiled ECD.

14. The method of claim 13, wherein processing the request comprises determining whether to allow the client to access to the content.

15. The method of claim 8, further comprising:
determining an expiration policy for the ECD; and
automatically applying the expiration policy for the ECD to the compiled ECD stored at the node.

16. The method of claim 8, further comprising:
receiving an indication at the node that the ECD has been invalidated; and
automatically marking the compiled ECD stored at the node as invalid.

17. A system for managing external customer data (ECD) in a network, comprising:
at least one processor;
memory, operatively connected to the at least one processor and storing instructions that, when executed by the at least one processor, cause the system to perform a method, the method comprising:
receiving, at a node of the network, ECD comprising a plurality of list entries;
determining whether all of the plurality of list entries comprise a same type of data; and
in response to determining that all of the plurality of list entries comprise the same type of data, automatically:
creating an array of the plurality of list entries;
sorting the array of the plurality of list entries; and
storing the sorted array.

18. The system of claim 17, wherein the method further comprises:
receiving a query from a script operating on the node whether the list entries comprise at least a particular entry;
searching the plurality of list entries using the sorted array; and
providing a response based on whether the particular entry matches one of the list entries.

19. The system of claim 17, wherein the node comprises an edge node of a content distribution network, and wherein receiving the metadata comprises receiving the metadata at the edge node from a control core of the content distribution network, the method further comprising:
receiving the ECD at the control core from a customer server; and
automatically propagating the ECD to the edge node.

20. The system of claim 17, wherein the method further comprises:
determining an expiration policy for the ECD; and
automatically applying the expiration policy for the ECD to the sorted array stored at the node.
